(19) United States
(12) Patent Application Publication
(10) Pub. No.: US 2012/0196484 A1
(43) Pub. Date: Aug. 2, 2012

(54) Through-Connector For A Metal Structure, And Associated Insulating Component And Metal Stucture

(75) Inventor: David Zieder, Sciez (FR)

(73) Assignee: Nicomatic SA, Bons-en-Chablais (FR)

(21) Appl. No.: 13/500,402

(22) PCT Filed: Sep. 14, 2010
(86) PCT No.: PCT/EP10/63422

§ 371 Date: Apr. 5, 2012

(30) Foreign Application Priority Data
Oct. 6, 2009 (FR) 09/04778

(51) Int. Cl. H01R 27/02

(52) U.S. Cl. 439/638

(57) ABSTRACT

The invention relates to a through-connector for a metal structure (1) having a through-opening, said through-connector comprising: at least one generally L-shaped connection pin (9) including a first arm (9a) and a second arm (9b) which are formed as a single piece; and at least one insulating component (11) to be secured in the opening and comprising at least one passage for receiving the pin (9), said passage including: a first portion which has a partially open circumference and is substantially parallel to the structure in order to receive the first arm (9a), retaining and orienting said arm such that, after mounting the free end thereof is maintained at a pre-determined distance from the structure, allowing reflow soldering; and a second portion which has a closed circumference and is substantially perpendicular to the first portion in order to receive the second arm (9b), retaining and orienting same in such a way that the free end thereof can come into contact with a mating connector.

The invention concerns a through-connector for an insulated metal support, on which are formed electrical connection tracks for electronic components, in particular components mounted on the surface of said support, referred to as surface-mounted components (SMC) or components using the surface-mounted technology (SMT). Such supports are known in trade as insulated metal supports (IMS).

Such a support conventionally includes a conductive metal plate on one face of which is disposed an insulative layer to insulate the electronic components electrically relative to the metal plate. This insulative layer is also thermally conductive so as to enable efficient evacuation of the heat dissipated by the electronic components. The heat dissipated by the electronic components is thus transmitted via the insulative layer to the metal plate while good electrical insulation is assured between the electronic components and the metal plate.

Such a support is particularly suitable for light-emitting diodes.

It is generally required that a light-emitting diode be connected to a power supply on the side opposite the side of the support carrying the light-emitting diode, and thus forming the illuminating side.

However, it is not possible to employ such a connection with the insulated metal support because the metal plate is conductive, which would cause a short circuit.

To the contrary, one known solution provides holes in the insulated metal support enabling wires to pass through for soldering on the insulated metal support. This solution necessitates relatively long manufacturing time and is particularly costly.

An objective of the invention is therefore to alleviate these drawbacks of the prior art by enabling a light-emitting diode carried by an insulated metal support to be connected by the side opposite the illuminating side.

To this end, the invention provides a through-connector intended to be mounted on a metal support having on a first face an insulative layer carrying at least one electronic component and including at least one opening through said support, characterized in that the connector includes at least one generally L-shaped connecting pin including first and second branches which are formed as a single piece, and at least one insulative part intended to be secured in said opening through said support and including at least one passage for receiving said at least one connecting pin, said receiving passage including: a first portion which has a partially open circumference substantially parallel to said support in order to receive said first branch, holding and orienting said first branch so that after mounting the free end of said first branch is held at a predefined distance from said support allowing reflow soldering, and a second portion which has a closed circumference substantially perpendicular to the first portion in order to receive said second branch, holding and orienting said second branch so that the free end of said second branch can come into contact with a mating connector.

Said connector may also have one or more of the following features separately or in combination:
said insulative part includes a cap configured to be disposed on the first face of said support and in which is formed said first portion of the passage receiving said connecting pin to receive said first branch, and
an insertion portion configured to be inserted in the opening in said support and in which is formed the second portion of the passage receiving said connecting pin to receive said second branch;
the cap of said insulative part includes a sealing lip with dimensions greater than the dimensions of the opening in said support disposed between the first branch of said connecting pin and said support;
said insulative part is configured to be fixed to said support by a bayonet mount;
the insertion portion of said insulative part has at its end opposite that connected to the cap an oblong portion of width less than the diameter of the insertion portion, said insertion and oblong portions corresponding to the shape of the opening in said support, so as: to authorize the insertion of the insertion portion and the oblong portion of said insulative part in the opening in said support, to authorize rotation of said insertion portion in the opening in said support after insertion, and to prevent removal of said oblong portion after rotation of said insertion portion;
said insulative part is configured to be clipped to said support and the insertion portion of said insulative part includes elastic clip means configured to cooperate with the second face of said support;
the elastic clip means include two clipping arms on respective opposite sides of the insertion portion of said insulative part respectively connected by a first end to the insertion portion and two slots respectively formed between the insertion portion and each clipping arm passing through said first ends;
each clipping arm carries at its second end a clip configured to abut against the second face of said support;
the elastic clip means further include two spring members disposed in the respective slots and respectively fixed on the one hand to a second end of the clipping arm and on the other hand to the facing insertion portion;
said insulative part further carries two locking members partially engaged in the respective slots, and each clipping arm carries at its second end deformation members configured to be pressed radially against the support and at least partially destroyed on total insertion of said locking member in the slot;
the facing walls of the insertion portion and the clipping arm have a shape complementary to the shape of the locking member;
the insertion portion of said insulative part is fixed to said support by a ring of adhesive disposed on the first face of said support around the opening in said support;
said insulative part is produced in plastic material;
said connector is configured to be clipped to the mating connector;
said connector includes a seal configured to be disposed between the connector and the mating connector; and
said connector incorporates electrical and/or electronic components for signal processing in said connecting pin and/or said insulative part.

The invention also relates to an insulative part for a through-connector of the invention, intended to be fixed in said opening through said support by a bayonet mount, characterized in that it includes:
at least one passage for receiving said at least one connecting pin, said receiving passage including a first portion which has a partially open circumference substantially parallel to said support in order to receive said first branch, holding and orienting said first branch so that after mounting the free end of said first branch is held at a predefined distance from said support allowing reflow soldering, and a second portion which has a closed circumference substantially perpendicular to the first portion in order to receive said second branch, holding and orienting said second branch so that the free end of said second branch can come into contact with a mating connector,
a cap configured to be disposed on the first face of said support and in which is formed said first portion of the passage receiving said connecting pin to receive said first branch, said cap having a sealing lip with dimensions greater than the dimensions of the opening in said support, disposed between the first branch of said connecting pin and said support,
an insertion portion configured to be inserted in the opening in said support and in which is formed the second portion of the passage receiving said connecting pin to receive said second branch.

The invention further relates to an insulative part for a through-connector according to the invention, characterized in that it includes:
a cap configured to be disposed on the first face of said support and in which is formed said first portion of the passage receiving said connecting pin to receive said first branch,
an insertion portion configured to be inserted in the opening in said support and in which is formed the second portion of the passage receiving said connecting pin to receive said second branch,
two clipping arms on respective opposite sides of the insertion portion of said insulative part respectively connected by a first end to the insertion portion, and respectively carrying at their second end a clip configured to abut against the second face of said support, and
two slots respectively formed between the insertion portion and each clipping arm passing through said first ends.

The invention further relates to a metal support having on a first face an insulative layer carrying at least one electronic component and including at least one opening through said support, characterized in that it carries at least one through-connector of the invention.

Said metal support may also have one or more of the following features separately or in combination:
said support carries on its first face a light-emitting diode connected to a power supply via the connector;
said support has on its first face an electrical connection track electrically connected both to the electronic component and to the first branch of said connecting pin.

Other features and advantages of the invention will become more clearly apparent on reading the following description, given by way of illustrative and nonlimiting example, and from the appended drawings, in which:

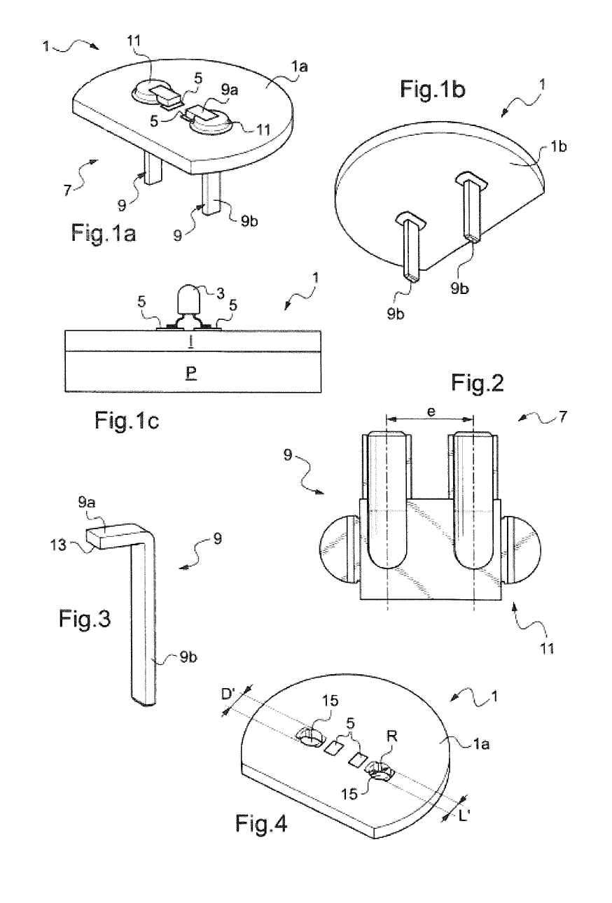

FIG. 1a is a perspective view from above an insulated metal support carrying two connectors of a first embodiment,

FIG. 1b is a perspective view from below of the support from FIG. 1a,

FIG. 1c is a view in cross section to a larger scale of the support from FIG. 1a,

FIG. 2 is a partial view from above of a two-point connector of the first embodiment,

FIG. 3 shows in perspective a connecting pin on the support from FIG. 1a,

FIG. 4 is a perspective view from above of the support from FIG. 1a before mounting a connector on the support,

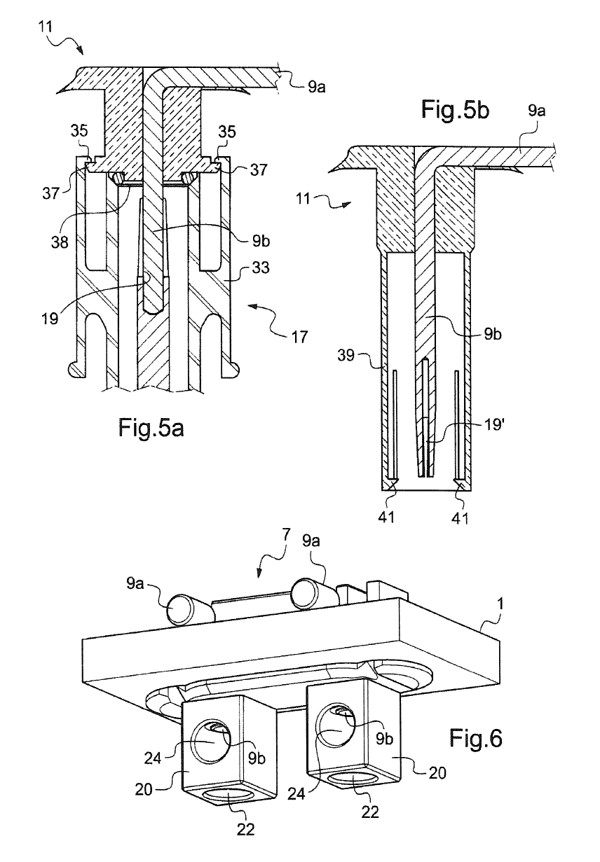

FIG. 5a shows in section a connecting pin and an insulative part of a connector of a first variant,

FIG. 5b shows in section a connecting pin and an insulative part of a connector of a second variant,

FIG. 6 is a perspective view of an insulated metal support fastened to a connector connected to a screw terminal block,

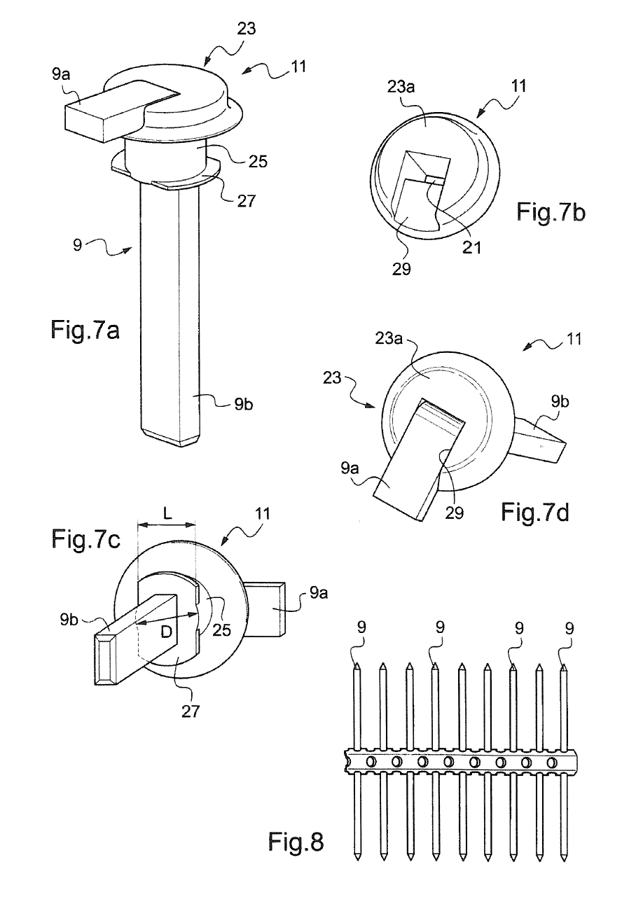

FIG. 7a is a perspective view of a connecting pin and an insulative part of a first embodiment,

FIG. 7b is a perspective view from above of the insulative part from FIG. 7a,

FIG. 7c is a perspective view from below of the connecting pin and the insulative part from FIG. 7a,

FIG. 7d is a perspective view from above of the connecting pin and the insulative part from FIG. 7a,

FIG. 8 shows connecting pins from FIG. 3 on a support strip before mounting on the support from FIG. 1a,

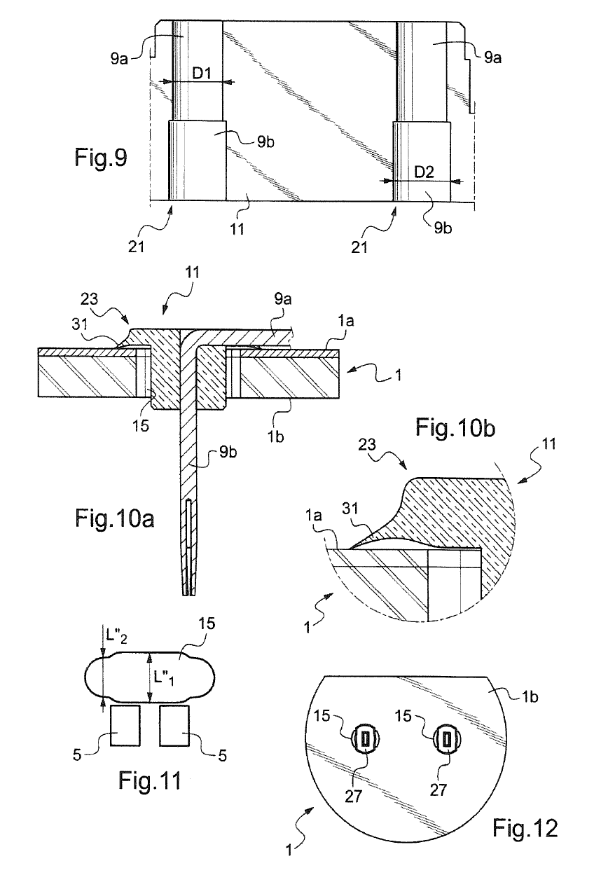

FIG. 9 is a view in partial cross section of a connector including cylindrical connecting pins,

FIG. 10a is a view in section of a connecting pin and an insulative part mounted on the support from FIG. 1a,

FIG. 10b is a view to a larger scale of a portion of FIG. 10a showing in more detail a sealing lip of the insulative part,

FIG. 11 is a detail view of the opening in the support for a two-point connector,

FIG. 12 is a view from below of the support from FIG. 1a carrying an insulative part,

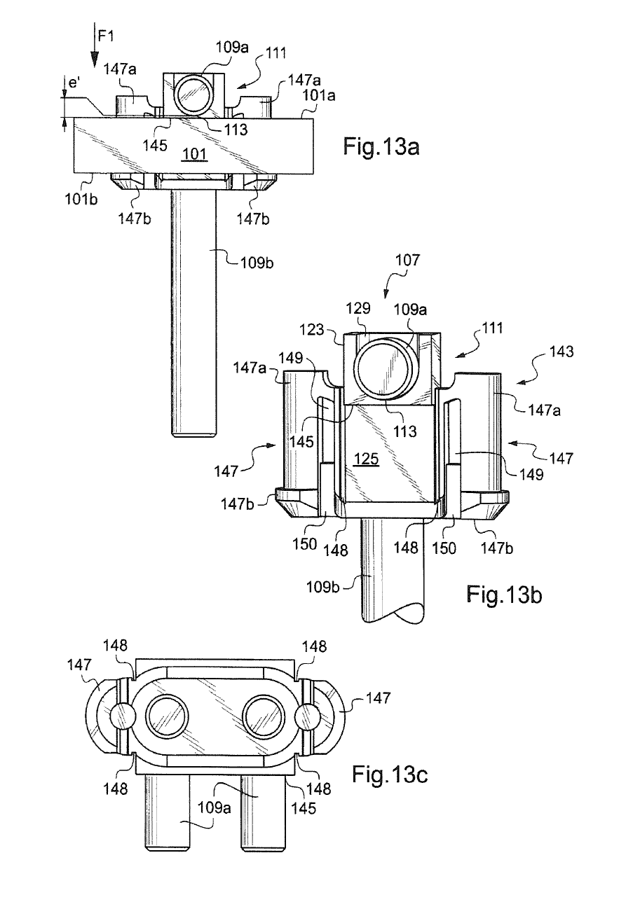

FIG. 13a shows an insulated metal support fastened to a connector in a second embodiment,

FIG. 13b is a partial front view of the connector from FIG. 13a,

FIG. 13c is a view from above of a two-point connector of the second embodiment,

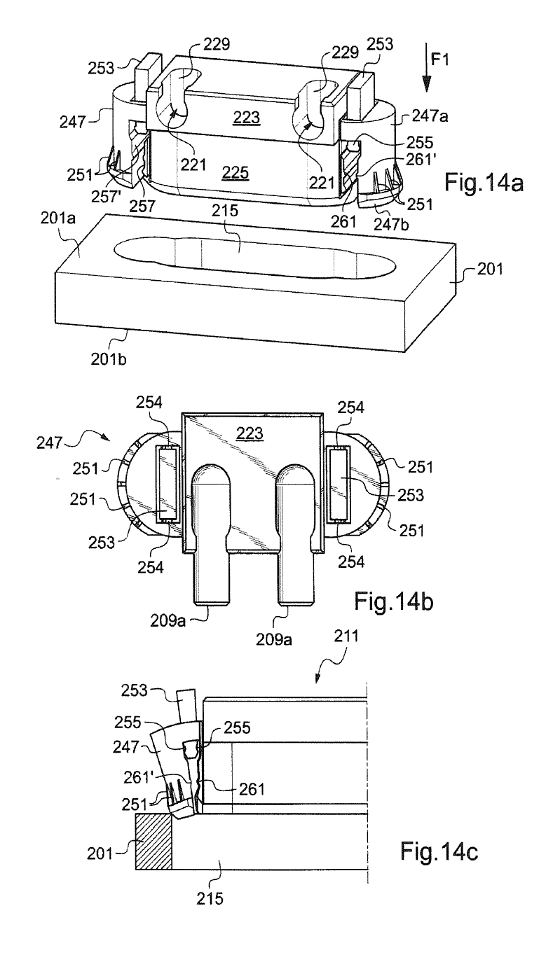

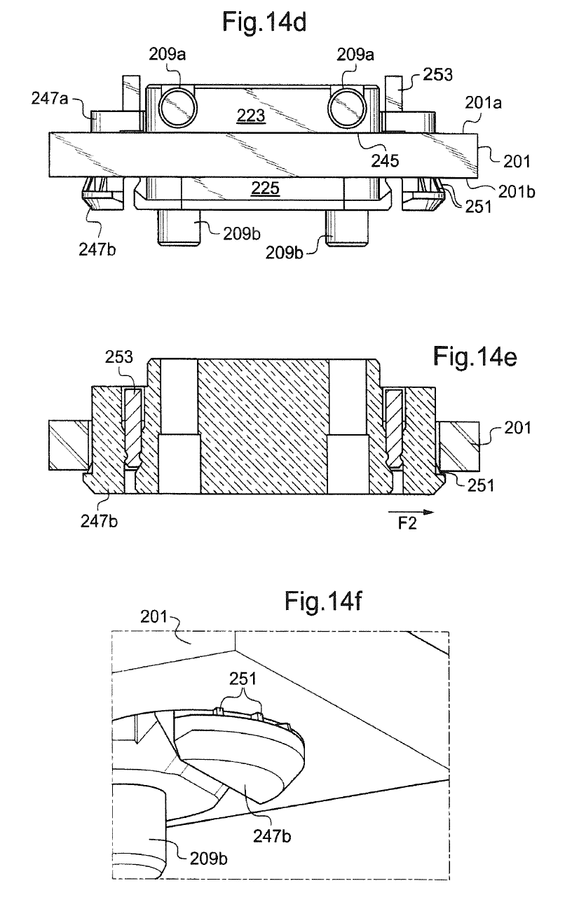

FIG. 14a shows a connector of a third embodiment before mounting on the insulated metal support,

FIG. 14b is a view from above of the connector from FIG. 14a,

FIG. 14c is a partial view in section showing in more detail the clipping means of the connector from FIG. 14a,

FIG. 14d is a front view of the connector from FIG. 14a in place on the support,

FIG. 14e is a view in section showing diagrammatically the locking of the connector from FIG. 14d to the support, and

FIG. 14f is a view showing a detail of the clipping means of the connector from FIG. 14d after mounting on the support.

In these figures, identical elements carry the same references. Furthermore, elements from FIGS. 13a to 13c, respectively 14a to 14f, identical to elements from FIGS. 1a to 12 carry the same references preceded by the hundreds digit 1, respectively the hundreds digit 2.

FIG. 1a to 1c show an insulated metal support (IMS) 1 with opposite first 1a and second 1b faces.

The support 1 conventionally comprises a conductive metal, for example aluminum, plate P and an insulative layer I, for example a Flame Resistant 4 (FR-4) layer disposed on the metal plate P. The first face 1a of the support is thus formed by the insulative layer I while the second face 1b is formed by the metal plate P.

The support 1 carries on its first face 1a electronic components such as a light-emitting diode 3. A control circuit for the light-emitting diode 3 may also be envisaged on the first face 1a. Electrical connection tracks 5 associated with the electronic components 3 are formed on the first face 1a of the insulative layer I.

These electronic components 3 are generally components mounted on the surface of the support 1, referred to as surface-mount components (SMC) or components using the surface-mount technology (SMT). The electronic components 3 may thus be reflow soldered to the associated connection tracks 5 on the first face 1a of the support 1.

The support 1 also transfers to the metal plate P heat dissipated by the electronic components 3 mounted on its first face 1a.

Moreover, the support 1 includes at least one connector 7 for connecting an electronic component 3 to a power supply (not shown).

To this end, the connector 7 comprises:
at least one connecting pin 9, and
an associated insulative part 11.

In the variant shown in FIGS. 1a and 1b, the connector 7 is a one-point connector. Of course, depending on the application, there may be provided a two-point connector as shown in FIG. 2 or a connector with three or four points, a greater number being possible depending on the application. Such multipoint connectors may be envisaged for routing a plurality of light-emitting diodes to a single connector, for example.

In the FIG. 2 variant, two connecting pins 9 are provided with a distance e between the two connecting pins 9 of 2.54 mm, for example and with a common insulative part 11 for the two connecting pins 9.

FIG. 3 shows in more detail a connecting pin 9 of the connector 7.

This connecting pin 9 includes a first branch 9a and a second branch 9b produced, preferably in brass, in one part with the first branch 9a, for example by cutting and bending.

In the example shown, the first 9a and second 9b branches of the connecting pin 9 are rectangular in cross section.

Alternatively, first and second branches 9a, 9b may be provided that are substantially circular (see FIG. 2), produced for example by bar turning.

This connecting pin 9 is generally L-shaped.

Moreover, referring to FIGS. 1a and 4, it is seen that the first branch 9a of the connecting pin 9 is in contact with an associated electrical connection track 5 formed on the first face 1a of the insulative layer I of the support 1 and in electrical contact with the electronic component 3 to be supplied with power.

The first branch 9a thus has a connecting area 13 (FIG. 3) for making electrical contact with the electronic component 3 via the associated electrical connection track 5.

In order to fix the connector 7 to the support 1 to maintain the electrical contact between the connecting area 13 of the first branch 9a and the associated electrical connection track 5, this connecting area 13 may be reflow soldered to the associated electrical connection track 5.

According to an alternative that is not shown, the connecting pin 9 is connected to the electronic component 3 directly and no longer via the associated electrical connection track 5. To this end, the first branch 9a of the connecting pin 9 may have at its free end a clip or a portion adapted to be crimped so as to be connected to the electronic component 3.

For its part the second branch 9b of the connecting pin 9 is inserted in an opening 15 provided in the support 1, for example produced by drilling, that extends from the first face 1a toward the second face 1b of the support 1 (see FIGS. 1a, 1b and 4).

This second branch 9b then comes into contact with a mating connector 17, shown in part in FIG. 5a, connected to the power supply. Of course, the mating connector 17 may equally form an integral part of the power supply.

To this end, the second branch 9b has at its free end a shape complementary to the shape of the free end of the mating connector 17.

In the example shown in FIG. 5a, the connecting pin 9a is a male pin and the second branch 9b is produced in the form of a contact prong that cooperates with a contact slot 19 of the mating connector 17.

Alternatively (FIG. 5b), the connecting pin 9a is a female pin and the second branch 9b includes a contact slot 19′ that cooperates with a contact prong (not shown) of the mating connector.

Of course, any other connecting means may be provided between the connector 7 and the mating connector 17, for example connecting means of the screw terminal block type, as shown in FIG. 6.

To this end, a terminal block 20 is connected to the second branch 9b of the connecting pin and includes an axial housing 22 to receive a mating connecting prong. This terminal block 20 also includes an opening 24 to receive screwing means, such as a screw/nut to ensure fixing. Conversely, the connecting prong may be received in the opening 24.

Moreover, for such a connection, the insulative part 11 is then configured to absorb the tightening torques.

Thus the connecting pin 9 enables the electronic component 3 to be connected to the power supply either directly or via the electrical connection tracks 5.

For applications necessitating electrical signal processing, this connecting pin 9 may also be configured to incorporate signal processing functions. Such a so-called intelligent connector incorporates electrical/electronic components, for example for filtering the signal. These electrical/electronic components may equally be incorporated into the insulative part.

Furthermore, the connecting pin 9 is at least partly surrounded by the insulative part 11 (FIGS. 7a to 7d) to isolate the connecting pin 9 relative to the metal plate P of the support 1, which is conductive. In this embodiment, one insulative part 11 is provided for one connecting pin 9. Alternatively a common insulative part may be provided that is sufficiently wide to insulate two or more connecting pins 9, as shown in FIG. 2.

The insulative part 11 includes a receiving passage 21 in which the connecting pin 9 is inserted (FIGS. 7a-7d). To this end, the receiving passage 21 is of complementary shape to the connecting pin 9.

To be more precise, the receiving passage 21 includes a first portion 29 of partially open circumference, for example formed by recess forming, substantially parallel to the support 1 to receive the first branch 9a and a second portion of closed circumference substantially perpendicular to the first portion 29, to receive the second branch 9b.

The first portion 29 holds and orients the first branch 9a so that the free end 13 of the first branch 9a is held after fitting at a predefined distance from the support, enabling reflow soldering, and the second portion holds and orients the second branch 9b so that the free end of the second branch 9b is able to come into contact with the mating connector 17.

To this end the connecting pin 9 may for example be produced by a cutting process and supported by a support strip as shown in FIG. 8. The insulative part 11 is then routed and inserted on the connecting pin 9 as far as the stop after which the connecting pin 9 is bent.

Alternatively, the connecting pin 9 is bent first, after which the second branch 9b of the connecting pin is inserted in the receiving passage 21 of the insulative part 11.

In another variant partially visible in FIG. 9, in which the connecting pin 9 is cylindrical, a change of section is provided so that the first branch 9a has a first diameter D1 and the second branch 9b has a second diameter D2 greater than the first diameter D1. In a complementary way, the first portion 29 of the receiving passage 21 of the insulative part 11 has a diameter of 1.15 mm, for example, to receive the first branch 9a of diameter D1 and the second portion of the receiving passage 21 is wider and has for example a diameter of 1.27 mm to receive the second branch 9b of diameter D2.

Thus the connecting pin 9 is inserted in the receiving passage 21 until the second branch 9b reaches the stop, after which the first branch 9a is bent to obtain the substantially L-shaped connecting pin 9.

Moreover, in the first embodiment shown in FIGS. 7a to 7d, the insulative part 11 includes:
a cap 23 disposed on the first face 1a of the support 1,
a substantially cylindrical insertion portion 25 of diameter D, and
an oblong portion 27 of width L less than the diameter D of the insertion portion 25, provided at the end of the insertion portion 25 opposite that connected to the cap 23,
   the insertion 25 and oblong 27 portions being inserted in the opening 15 in the support 1 so as to pass through the support 1.

These three parts 23, 25 and 27 of the insulative part 11 are formed in one piece, for example by injection molding plastic material, such as polyetheretherketone (PEEK) or polyphenylene sulfide, also known as polysulfide of phenylene (PSP), in order to guarantee good electrical insulation and good temperature resistance up to reflow temperatures without structural modification.

The cap 23 has a plane portion 23a enabling manipulation of the connector 7 to mount it on the support 1, for example. This plane portion 23a may be adapted as a function of the intended manipulation, for example for manipulation by a clamp gripping lugs may be provided on the plane portion 23a of the insulative part 1.

Moreover, the first portion 29 of the receiving passage 21 is provided on the plane portion 23a to receive the first branch 9a of the connecting pin 9. Of course, this first portion 29 is produced with a shape complementary to that of the first branch 9a to be received, for example substantially rectangular in the FIG. 7b example or as a variant substantially cylindrical in the FIG. 2 example.

Moreover, the cap 23 has a sealing lip 31 seen more clearly in FIGS. 10a and 10b. This sealing lip 31 has dimensions greater than those of the opening 15 in the support 1 so as to cover the opening 15, being disposed between the first branch 9a of the connecting pin 9 and the first face 1a of the support 1. This produces a totally hermetically sealed first face 1a of the support 1.

However, to enable electrical contact between the connecting pin 9 and the associated electrical connection track 5 of the support 1, the dimensions of the sealing lip 31 are adapted to leave free the space between the connecting area 13 of the first branch 9a of the connecting pin 9 and the associated electrical connection track 5.

The sealing lip 31 disposed in this way constricts the insulative part 11 and the associated connecting pin 9 in the opening 15 of the support 1, which has the effect of holding the connector 7 in position before fixing it to the support 1, for example by soldering the first branch 9a of the connecting pin 9 to the first face 1a of the support 1.

Moreover, this sealing lip 31 has sufficient elasticity to compensate the thickness differences between a plurality of supports 1.

To be more precise, the connector 7 may be fitted to a plurality of supports 1 having different thicknesses. The elasticity of the lip 31 is then configured to compensate predefined thickness tolerances. For example, for a support 1 of standard 1.635 mm thickness, a tolerance of plus or minus 0.16 mm is provided that may be compensated by the sealing lip. Thus the connector 7 may equally well be fitted to a support 1 of 1.5 mm thickness or to a support 1 of 1.7 mm thickness.

As an alternative to this sealing lip 31, an O-ring seal (not shown) may be disposed around the opening 15 in the support 1, between the cap 23 and the first face 1a of the support 1.

Moreover, the second portion of the receiving passage 21 is provided in the insertion portion 25. Of course, this second portion is produced with a shape complementary to that of the second branch 9b to be received, for example substantially rectangular in the FIG. 7b example or as a variant substantially cylindrical in the FIG. 2 example.

Moreover, the insertion portion 25 and the oblong portion 27 (FIGS. 7a, 7c) have appropriate shapes to be able to be inserted into the opening 15 in the support 1 and to enable rotation of the insertion portion 25 for bayonet mounting on the support 1.

To be more precise, referring again to FIG. 4, it is seen that the opening 15 has an oblong general shape of width L′ complementary to the shape of the oblong portion 27 of the insulative part 11 to enable insertion of the oblong part 27 in the opening 15.

Furthermore, the opening 15 has substantially at its center a convex circular arc of radius R at each longitudinal end of the oblong shape. This radius R is thus chosen so that the radius R is greater than half the width L′, the circular arcs thus delimiting a virtual cylindrical orifice represented in dashed line of diameter D′ greater than the width L′, as in equation (1):

D′=2×R>L′ (1)

The shape of this cylindrical orifice is complementary to that of the insertion portion 25 of the insulative part 11 to enable insertion and rotation of the insertion portion 25 in the opening 15 of the support 1.

Alternatively, in the case of a two-point connector 7 (FIG. 2), the insertion portion 25 of the insulative part 11 becomes a substantially oblong portion to receive the two connecting pins 9, of width greater than the oblong portion 27 width, and the opening 15 (FIG. 11) has an oblong general shape with a central part of width L₁″ to receive the insertion portion 25 and circular-arc-shaped ends of maximum width L₂″ less than the width L₁″, enabling the oblong portion 27 to be received.

Such an opening 15, the geometry of which is adapted for the connector 7 to pass through whether it be a single-point connector (FIG. 4) or a two-point (FIG. 11) connector is simple to produce, for example by drilling and/or machining.

Moreover, once the rotation of the insertion portion 25 has been effected, in the example shown in FIG. 12 through an angle of 90°, the oblong portion 27 is then perpendicular to the opening 15 of the support 1, thereby preventing removal via the opening 15 of the insulative part 11 and thus the connecting pin 9. The connector 7 and the insulated metal support 1 are thus fastened together mechanically.

By way of example, the connector 7 may thus be mounted on the support 1 as follows:
the connecting pin 9 and the insulative part 11, fastened together, are inserted in the opening 15 in the support 1 so that the cap 23 abuts against the first face 1a of the support 1 and the second branch 9b of the connecting pin passes through the support 1 to come into contact with the mating connector 17,
the insulative part 11 is rotated through an angle of 90°, for example, until the connecting area 13 of the first branch 9a of the connecting pin 9 faces the associated electrical connection track 5 of the support 1, and
the first branch 9a is reflow soldered to the associated electrical connection track 5.

Moreover, referring again to FIGS. 5a, 5b, it is seen that the insulative part 11 may be fixed, for example clipped, to the mating connector 17 to guarantee a connection between the two connectors 7 and 17.

To this end, in a first variant shown in FIG. 5a, the mating connector 17 has a cylindrical skirt 33 that in this example surrounds the contact slot 19 and has at its end clipping hooks 35 that cooperate with complementary clipping counter-hooks 37 carried at the free end of the insulative part 11.

Moreover, a compressed O-ring seal 38 may be provided between the cylindrical skirt 33 of the mating connector 17 and the insulative part 11. This seal 38 improves the seal between the two connectors 7 and 17.

In a second variant shown in FIG. 5b, it is the insulative part 11 of the connector 7 that has a cylindrical skirt 39, in this example surrounding the contact slot 19′ and having at its free end clipping hooks 41 that cooperate with complementary clipping counter-hooks (not shown) of the mating connector.

Of course, any other method of fixing the two connectors 7 and 17 may be envisaged.

In a second embodiment shown in FIGS. 13a to 13c, the insulative part 111 is mounted on the support 101 by clipping and no longer by a bayonet mount as described above.

In this case, an oblong portion of the insulative part 111 is of no utility, and the insertion portion 125 of the insulative part includes elastic clip means 143 cooperating with the second face 101b of the support 101, the effect of which is to hold the connector 107 in position before it is fixed to the support 101, for example by soldering the first branch 109a of the connecting pin 109 to the first face 101a of the support 101.

These elastic clip means are also configured to compensate the predefined thickness tolerances of the supports 101, like the elastic lip 31 of the first embodiment.

To be more precise, in the example shown in FIGS. 13a and 13b, the connector 107 includes a cap 123 of substantially parallelepiped general shape and an insertion portion 125.

The cap 123 projects radially relative to the insertion portion 125 and has dimensions greater than those of the opening 115 in the support 1 to cover it when disposed between the first branch 109a of the connecting pin 109 and the first face 101a of the support 101, thus forming a stop 145 against the first face 101a of the support 101.

Nevertheless, to enable electrical contact between the first branch 109a of the connecting pin 109 and the associated electrical connection track 105 of the support 101, the dimensions of the cap 123 are adapted to leave free the space between the connecting area 113 of the first branch 109a of the connecting pin 109 and the associated electrical connection track 105.

By way of example, the thickness e′ between the stop 145 and the first portion 129 of the receiving passage 121 is of the order of 0.1 mm.

The insertion portion 125 of the insulative part 111 carries laterally the elastic clip means 143. The cap 123, the insertion portion 125 and these elastic clip means 143 are produced in one piece.

In the embodiment shown, the elastic clip means 143 are diametrically opposite each other on respective opposite sides of the insertion portion 125 and respectively include:
a clipping arm 147 the first end 147a of which is radially connected to the insertion portion 125 and the second end 147b of which opposite the first end 147a includes a clip taking the form of a hook or harpoon, for example, adapted to abut against the second face 101b of the support 101, and
a slot 149 between the insertion portion 125 and the clipping arm 147 passing through the first end 147a of the clipping arm 147.

In the example shown, the insertion portion 125 has two substantially rectangular lateral faces connected to the clipping arms 147.

Moreover, four axial grooves 148 seen better in FIGS. 13b and 13c are provided on the insertion portion 125. To be more precise, a groove 148 is produced in the vicinity of each extremity of the lateral faces of the insertion portion 125. These grooves 148 provide a passage for drilling and machining waste formed when producing the opening 115 in the support 101.

Thus the clamping torques are absorbed in the case of screw terminal block type connections between the mating connectors, for example (FIG. 6).

A spring member 150 may be disposed in the slot 149 between the insertion portion 125 and the clipping arm 147 at the level of its second end 147b, the spring member 150 being fixed on the one hand to the second end 147b and to the surface of the insertion portion 125 facing the second end 147b.

As seen better in FIG. 13c, the clipping arm 147 has a substantially rounded general shape corresponding to the shape of the circular-arc-shaped end of the associated opening 115 in the support 101, as described above.

Furthermore, as in the first embodiment, the number of points of the connector 107 may be varied according to the application. By way of example, FIGS. 13a and 13b show a single-point connector 107 of the second embodiment and FIG. 13c shows a two-point connector 107 of the second embodiment.

Accordingly, for mounting the connector 107 on the support 101, the second branch 109b of the connector 107 is inserted in the associated opening 115 in the support 101 in the direction of the arrow F1 shown in FIG. 13a in the case of mounting from the front, and a bearing force is exerted in the direction of the arrow F1 on the connector 107 so that the clip 147b passes through the support 101 until the stop 145 on the cap 143 comes to bear against the first face 101a of the support 101.

When the force is released, the clip 147b abuts against the second face 101b of the support 101. With the connector 107 held in position in this way, the connector 107 and the support 101 may be fixed by soldering the connecting pin or pins 109 to the electrical connection tracks on the first face 101a of the support 101.

A third embodiment shown in FIGS. 14a to 14f differs from the second embodiment in that the clip-shaped second end 247b of each clipping arm 247 also carries at least one deformation member 251 intended to be deformed or destroyed when mounting the connector 207 on the support 201.

The deformation members 251 are uniformly distributed along the circumference of the clipping arm 247 at the level of the clip 247b, being spaced at a predefined constant pitch.

These deformation members 251 are represented in the form of ribs in the example shown. Other suitable shapes may be employed for these deformation members 251, for example a staircase shape.

In this third embodiment, a locking member 253 is carried by the clipping arm 247 being partly engaged in the slot 249 and retained by means of elastic temporary fixing members 254 shaped to brake when an axial bearing force in the direction of the arrow F1 is exerted on the locking member 253. The locking member 253 is then inserted completely in the slot 249 to load the clipping arm 247 radially, pushing the deformation members 251 against the support 201 until they are deformed or destroyed.

To this end, the slot 249 has a shape complementary to that of this locking member 253.

Moreover, the walls 257 and 257′ include respective facing ribs 261, 261′ associated with a groove 255 on the locking member 253 and respectively engaged in the associated grooves 255 when a bearing force in the direction of the arrow F1 is exerted on the locking member 253.

The connector 207 can thus be mounted on the support 201 as described hereinafter.

The second branch 209b of the connector 207 is inserted in the associated opening 215 in the support 201 in the direction of the arrow F1 shown in FIG. 14a in the case of mounting from the front, and a bearing force is exerted in the direction of the arrow F1 on the connector 207 (FIG. 14c) so that the second end 247b of the clipping arm passes through the support 201 until the stop 245 on the cap 243 comes to bear against the first face 201a of the support 201 (FIG. 14d).

A bearing force in the direction of the arrow F1 is then exerted on the locking member 253 to break the elastic temporary fixing members 254 so that the locking member 253 is inserted in the slot 249 until the ribs 257, 257′ engage in the grooves 255 on the locking member 253 (FIG. 14e).

A radial force F2 then presses the deformation members 251 against the support 201, which breaks them, for example (FIGS. 14e and 14f).

The connector 207 and the support 201 are then fixed, for example by soldering the connecting pin or pins 209 to the electrical connection tracks on the first face 201a of the support 201.

A fourth embodiment (not shown)may be provided, in which the insulative part 11 is glued to the support 1.

In this case, a ring of adhesive (not shown), for example silicone or hot-melt adhesive, may be disposed on the first face 1a of the support 1 around the opening 15 in the support 1 in such a manner as to adhesive the cap 23 of the insulative part 11 against the first face 1a of the support 1.

The ring of adhesive then combines the functions of sealing the first face 1a of the support 1 and fixing the connector 7 to the support 1.

It is thus clear that such an insulated metal support 1, 101, 201 fastened in this way to the connector 7, 107, 207 of the invention provides a simple way of connecting an electronic component, such as a light-emitting diode 3, to a power supply from the rear of the support 1, at the same time as guaranteeing good mechanical strength and good sealing of the support 1, 101, 201.

1-21. (canceled)

22. A through-connector for mounting on a metal support having on a first face an insulating layer having at least one electronic component, and having at least one opening traversing the support, characterized in that the connector comprises:
at least one connecting pin having a generally L-shape with a first branch and a second branch formed in one piece, and
at least one insulating part configured to be disposed in the at least one opening of the support, and comprising at least one receiving passage for said at least one connecting pin, said receiving passage having:
a first portion of partially open circumference, substantially parallel to the support, for receiving said first branch, maintaining and guiding said first branch so that a free end of said first branch is held after assembly at a predetermined distance from said support to allow reflow soldering, and
a second portion of closed circumference, substantially perpendicular to said first portion for receiving said second branch maintaining and guiding said second branch so that a free end of said second branch can come into contact with a mating connector.

23. The connector of claim 22 wherein said insulating part comprises:
a cap configured to be disposed on the first face of said support and in which is formed said first portion of the receiving passage of said connecting pin for receiving said first branch, and
an insertion portion configured to be inserted into the at least one opening of said support, and in which is formed the second portion of the receiving passage of said connecting pin for receiving said second branch.

24. The connector of claim 23 wherein the cap of said insulating part further comprises a sealing lip of dimensions greater than the dimensions of the at least one opening of the support, interposed between the first branch of said connecting pin and said support.

25. The connector of claim 22, wherein said insulating part is configured to be fixed to said support by a bayonet mount.

26. The connector of claim 23, wherein the insertion portion of said insulating part has an oblong portion of width less than the diameter of the insertion portion, said insertion portion and said oblong portion corresponding to the shape of the opening in said support, so as:
to enable the insertion of the insertion portion and the oblong portion of said insulative part in the opening in said support,
to enable rotation of said insertion portion in the opening in said support after insertion, and
to prevent removal of said oblong portion after rotation of said insertion portion.

27. The connector of claim 23, wherein said insulative part is configured to be clipped to said support and wherein the insertion portion of said insulating part comprises elastic clip means configured to cooperate with the second face of said support.

28. The connector of claim 27, wherein the elastic clip means comprise:
two clipping arms on respective opposite sides of the insertion portion of said insulating part respectively connected by a first end to the insertion portion, and
two slots respectively formed between the insertion portion and each clipping arm passing through said first ends.

29. The connector of claim 28, wherein each clipping arm carries at its second end a clip configured to abut against the second face of said support.

30. The connector of claim 29, wherein the elastic clip means further comprise two spring members disposed in the respective slots and respectively fixed to the second end of the clipping arm and to the insertion portion.

31. The connector of claim 29, wherein:
said insulating part further carries two locking members partially engaged in the respective slots, and
each clipping arm carries at its second end deformation members configured to be pressed radially against the support and at least partially destroyed on total insertion of said locking member in the slot.

32. The connector of claim 31, wherein the insertion portion and the clipping arm are adapted to mate with said locking members.

33. The connector of claim 23, wherein the insertion portion of said insulating part is fixed to said support by adhesive disposed on the first face of said support around the at least one opening in said support.

34. The connector of claim 22, wherein said insulating part is comprised of a plastic material.

35. The connector of claim 22, further comprising means for attaching to the mating connector.

36. The connector of claim 23, further comprising a seal disposed between the connector and the mating connector.

37. The connector of claim 23, further comprising at least one signal processing component disposed in said connecting pin and/or said insulating part.

38. The connector of claim 22, wherein said at least one electronic component is a light-emitting diode connected to a power supply via the connector.

39. The connector of claim 38, wherein said first face of said support has disposed thereon an electrical connection track electrically connected both to the electronic component and to the first branch of said connecting pin.
